(19) United States
(12) Patent Application Publication
(10) Pub. No.: US 2022/0083917 A1
(43) Pub. Date: Mar. 17, 2022

(54) DISTRIBUTED AND FEDERATED LEARNING USING MULTI-LAYER MACHINE LEARNING MODELS

(71) Applicant: VMware, Inc., Palo Alto, CA (US)

(72) Inventors: Yaniv Ben-Itzhak, Afek (IL); Shay Vargaftik, Nazareth-Illit (IL)

(21) Appl. No.: 17/021,454

(22) Filed: Sep. 15, 2020

(51) Int. Cl. G06N 20/20; G06F 16/2455

(52) U.S. Cl. CPC G06N 20/20; G06F 16/2455

(57) ABSTRACT

In one set of embodiments, a computing node in a plurality of computing nodes can train a first ML model on a local training dataset comprising a plurality of labeled training data instances, where the training is performed using a distributed/federated training approach across the plurality of computing nodes and where the training results in a trained version of the first ML model. The computing node can further compute, using the trained version of the first ML model, a training value measure for each labeled training data instance in the local training dataset and identify a subset of the plurality of labeled training data instances based on the computed training value measures. The computing node can then train a second ML model on the subset, where the training of the second ML model is performed using the distributed/federated training approach.

### BACKGROUND

Distributed learning is a machine learning (ML) paradigm that involves training a single (i.e., “global”) ML model on training data spread across multiple computing nodes (e.g., a first training dataset X₁ local to a first node N₁, a second training dataset X₂ local to second node N₂, etc.). Federated learning is similar to distributed learning but includes the caveat that the local training dataset of each node is private to that node; accordingly, federated learning is designed to ensure that the nodes do not reveal their local training datasets to each other as part of the training process.

In many real-world use cases (e.g., IoT (Internet of Things) edge computing, mobile device fleets, etc.), the implementation of distributed and/or federated learning is subject to resource constraints such as limited network bandwidth between nodes and limited compute, memory, and/or power capacity per node. These resource constraints are exacerbated by the privacy requirements of federated learning, which typically impose additional overhead due to the need for encryption or other privacy-preserving mechanisms. The foregoing factors generally make the training of an ML model via distributed or federated learning a time-consuming and difficult process.

### BRIEF DESCRIPTION OF THE DRAWINGS

FIG. 1 depicts a first system environment.

FIG. 2 depicts a flowchart for training an ML model using a parameter-based distributed/federated learning approach.

FIG. 3 depicts a second system environment according to certain embodiments.

FIG. 4 depicts a flowchart for training a multi-layer ML model in a distributed/federated fashion according to certain embodiments.

FIG. 5 depicts a flowchart for processing a query data instance using the multi-layer ML model trained via FIG. 4 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

The present disclosure is directed to techniques for more efficiently implementing distributed and/or federated learning through the use of multi-layer ML models. As used herein, a “multi-layer” ML model is an ML model that is composed of at least two sub-models: a first (i.e., primary) model that is relatively small and/or simple in structure and a second (i.e., secondary) model that is larger and/or more complex.

At a high level, the techniques of the present disclosure comprise training, by a plurality of nodes, a global multi-layer ML model on the nodes' local training datasets by: (1) training the primary model in a distributed/federated fashion on the entireties (or sub-samplings) of those local training datasets, (2) computing, by each node using the trained version of the primary model, a “training value” measure for each labeled training data instance in the node's local training dataset, where this training value measure indicates how useful/valuable the labeled training data instance is for training purposes, (3) identifying, by each node, a subset of its local training dataset based on the computed training value measures (e.g., the labeled training data instances deemed most valuable for training), and (4) training the secondary model in a distributed/federated fashion on the identified subsets (or sub-samplings of the identified subsets).

The techniques of the present disclosure further comprise receiving, by a given node in the plurality of nodes, a query data instance (i.e., an unlabeled data instance for which a prediction is desired) and processing the query data instance using the trained version of the global multi-layer ML model by: (1) providing the query data instance as input to the trained version of the primary model, (2) generating, via the trained version of the primary model, a prediction and associated prediction metadata (e.g., a confidence level) for the query data instance, and (3) determining whether the prediction metadata indicates that the primary model is sufficiently confident in its prediction. If the prediction metadata indicates that the primary model is sufficiently confident, the node can output the primary model's prediction as the query data instance's final prediction result. However, if the prediction metadata indicates that the primary model is not sufficiently confident, the node can provide the query data instance as input to the trained version of the secondary model. In response, the trained version of the secondary model can generate a prediction for the query data instance and the node can output the secondary model's prediction as the query data instance's final prediction result.

### 2. System Environment

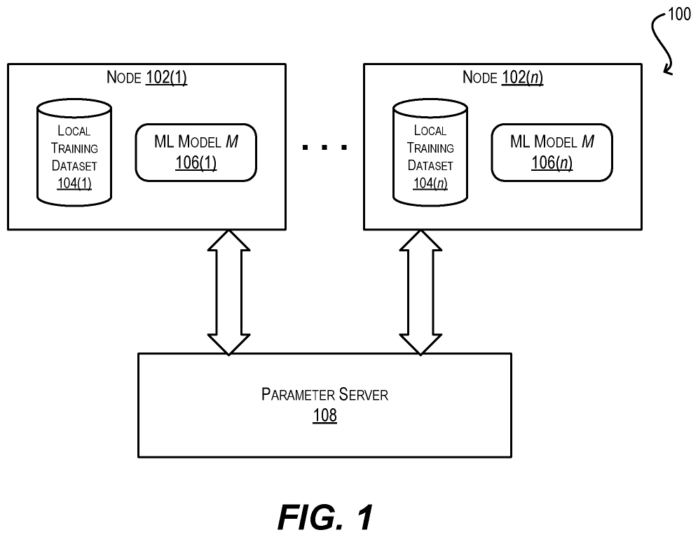

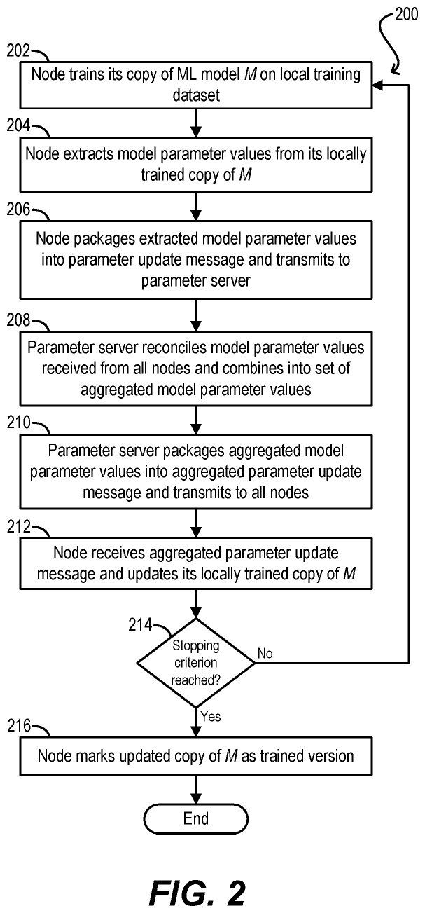

To provide context for the techniques described herein, FIG. 1 depicts a system environment 100 comprising a plurality of computing nodes 102(1)-(n)—each including a local training dataset 104 and a copy of a global ML model M (reference numeral 106)—and FIG. 2 depicts a flowchart 200 that may be executed by these nodes for training ML model M using (or in other words, “on”) local training datasets 104(1)-(n) in a distributed/federated fashion according to a conventional, “parameter-based” distributed/federated learning approach. It is assumed that each local training dataset 104(i) for i=1, . . . , n resides on a storage component of its respective node 102(i) and comprises a set of labeled training data instances that are specific to node 102(i). Each labeled training data instance d in local training dataset 104(i) includes a feature set x representing the data attributes/features of d and a label y indicating the “correct prediction” for d (in other words, the prediction that should be generated by an ML model that is trained on d). In addition, if nodes 102(1)-(n) are configured to employ federated (rather than distributed) learning, it is assumed that local training datasets 104(1)-(n) are private to their respective nodes, such that local training dataset 104(i) is only visible to and accessible by node 102(i).

Starting with blocks 202 and 204 of flowchart 200, each node 102(i) can train its copy of ML model M (i.e., 106(i)) on local training dataset 104(i) (resulting in a locally trained copy 106(i)) and can extract certain model parameter values from the locally trained copy that describe its structure. By way of example, if ML model M is a random forest classifier, the model parameter values extracted at block 204 can include the number of decision trees in locally trained copy 106(i) of M and the split attributes and split values for each node of each decision tree. As another example, if ML model M is a neural network classifier, the model parameters can include the neural network nodes in locally trained copy 106(i) of M and the weights of the edges interconnecting those neural network nodes. In a federated learning scenario, these model parameter values can be selected such that they do not reveal anything regarding each node's local training dataset.

At block 206, each node 102(i) can package the extracted model parameter values into a “parameter update” message and can transmit the message to a centralized parameter server that is connected to all nodes (shown via reference numeral 108 in FIG. 1). In response, parameter server 108 can reconcile the various model parameter values received from nodes 102(1)-(n) via their respective parameter update messages and combine the reconciled values into an aggregated set of model parameter values (block 208). Parameter server 108 can then package the aggregated set of model parameter values into an aggregated parameter update message and transmit this aggregated message to nodes 102(1)-(n) (block 210).

At block 212, each node 102(i) can receive the aggregated parameter update message from parameter server 108 and update its locally trained copy 106(i) of M to reflect the model parameter values included in the received message, resulting in an updated copy 106(i) of M. For example, if the aggregated parameter update message specifies a certain set of split features and split values for a given decision tree t₁ of ML model M, each node 102(i) can update t₁ in its locally trained copy 106(i) of M to incorporate those split features and split values. Because the model updates performed at block 212 are based on the same set of aggregated model parameter values sent to every node, this step results in the convergence of copies 106(1)-(n) of M such that these copies are identical across all nodes.

Upon updating its locally trained copy 106(i), each node 102(i) can check whether a predefined criterion for concluding the training process of ML model M has been met (block 214). This criterion may be, e.g., a desired level of accuracy for M, a desired number of training rounds, or something else. If the answer at block 214 is no, each node 102(i) can return to block 202 in order to repeat blocks 202-214 as part of the next round for training M. In addition, although not shown, in certain embodiments parameter server 108 may decide to conclude the training process at the current round; in these embodiments, parameter server 108 may include a command in the aggregated parameter update message sent to each node that instructs the node to terminate the training after updating its respective locally trained copy of M.

However, if the answer at block 214 is yes, each node 102(i) can mark its updated copy 106(i) of M as the trained version of the model (block 216) and terminate the training process. As indicated above, because the per-node copies of M converge at block 212, the end result of this training process is a single (i.e., global) trained version of M that is consistent across copies 106(1)-(n) of nodes 102(1)-(n) and is trained in accordance with the training data applied at block 202 (i.e., local datasets 104(1)-(n)). Although not shown in FIG. 2, each node 102(i) can subsequently use its copy 106(i) of the trained version of M during a query processing phase to generate and output predictions for query data instances received at the node.

As mentioned in the Background section, one challenge with implementing distributed/federated learning as it exists today is that it is too resource intensive to use in many real-world use cases/scenarios. For example, with respect to the parameter-based distributed/federated training approach shown in FIG. 2, if the sizes of local datasets 104(1)-(n) are large and/or the complexity of global ML model M is high, the amount of resources needed to train model M (in terms of, e.g., network bandwidth for parameter updates, per-node compute, per-node memory, etc.) will also be high, which makes it impractical for lower-power computing nodes such as IoT devices, mobile/handheld devices, and so on.

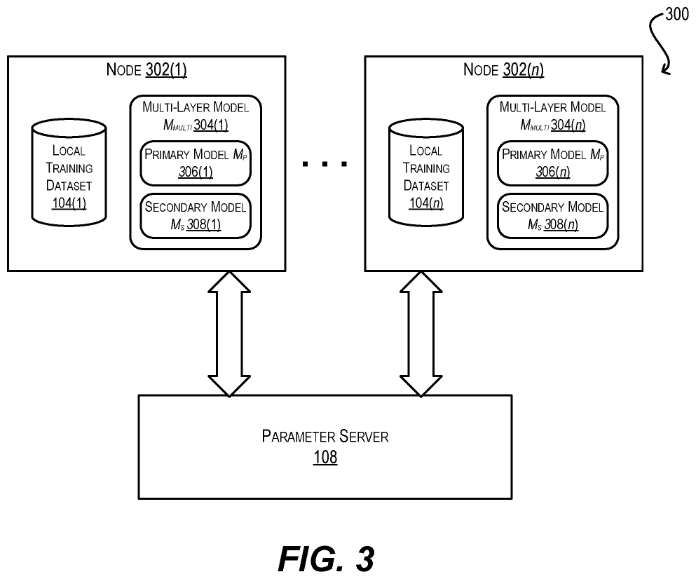

To address this problem, FIG. 3 depicts a modified version of system environment 100 of FIG. 1 (i.e., system environment 300) that includes a set of enhanced nodes 302(1)-(n) according to certain embodiments. Enhanced nodes 302(1)-(n) are configured to implement a novel distributed and/or federated learning approach that involves training and applying a global multi-layer ML model Mₘᵤₗₜᵢ (reference numeral 304) in place of global ML model M of FIG. 1. As shown in FIG. 3, global multi-layer ML model Mₘᵤₗₜᵢ is composed two sub-models: a primary model Mₚ (reference numeral 306) and a secondary model Mₛ (reference numeral 308). Primary model Mₚ is designed to be a relatively small and/or simple in structure whereas secondary model Mₛ is designed to be larger and/or more complex. For instance, My may be a random forest classifier that is limited to less than 100 decision trees and a maximum tree height of 10 while secondary model Mₛ may be a neural network classifier that is allowed to have thousands (or more) neural network nodes.

As detailed in section (3) below, nodes 302(1)-(n) can carry out a process for training global multi-layer ML model Mₘᵤₗₜᵢ by first training primary model Mₚ in a distributed/federated fashion (e.g., using the parameter-based distributed/federated training approach shown in FIG. 2) on the entire (or sub-sampled) contents of their respective local training datasets 104(1)-(n). Each node 302(i) can then compute, using its copy 306(i) of the trained version of Mₚ, a training value measure for each labeled training data instance in local training dataset 104(i), where this training value measure indicates the value/importance of the labeled training data instance for training purposes (or stated another way, the degree to which using the labeled training data instance for training a given ML model would likely change/affect the output of the trained model). In a particular embodiment, this training value measure can be computed as the inverse of the “predictability” measure disclosed in commonly owned U.S. patent application Ser. No. 16/908,498, filed Jun. 22, 2020, entitled “Predictability-Driven Compression of Training Data Sets,” which is incorporated herein by reference for all purposes.

Upon computing the training value measures for all labeled training data instances in local training dataset 104(i), each node 302(i) can identify, based on the training value measures, a subset of local dataset 104(i) that will be used for training secondary model Mₛ. In one set of embodiments, each node 302(i) can perform this subset identification independently (i.e., solely in view of the training value measures of its local training dataset 104(i)). In other embodiments, nodes 302(1)-(n) can exchange statistics regarding the training value measures of their respective local training datasets 104(1)-(n) and, based on the exchanged statistics, each node 302(i) can identify a subset of its local training dataset 104(i) that satisfies one or more global objectives or properties for the overall aggregation of subsets across all nodes 302(1)-(n).

Finally, nodes 302(1)-(n) can train secondary model Mₛ in a distributed/federated fashion (e.g., using the parameter-based distributed/federated training approach shown in FIG. 2) on the identified subsets (or sub-samplings thereof), thereby completing the training of global multi-layer ML model Mₘᵤₗₜᵢ.

In addition to the foregoing, as detailed in section (4) below, each node 302(i) can carry out a process for processing an incoming query data instance q (i.e., a data instance that has a feature set x but no corresponding label y) using the trained version of global multi-layer ML model Mₘᵤₗₜᵢ, thereby generating a prediction for q. This process can involve first providing q as input to copy 306(i) of the trained version of primary model Mₚ (resulting in a prediction p_{primary} and associated prediction metadata m_{primary}). If prediction metadata m_{primary} indicates that My is sufficiently confident in the correctness of prediction p_{primary}, node 302(i) can output p_{primary} as the final prediction result for q and the query processing can end.

On the other hand, if p_{primary} indicates that My not sufficiently confident in the correctness of p_{primary}, node 302(i) can proceed to provide q as input to copy 306(i) the trained version of secondary model Mₛ (resulting in a prediction p_{secondary}). Node 302(i) can then output p_{secondary} as the final prediction result for q and terminate the query processing.

With the general architecture and approach described above, a number of benefits are achieved. First, because primary model Mₚ is small in size/complexity and because secondary model Mₛ is trained using a only portion of the local training datasets of nodes 302(1)-(n), the resources needed to train global multi-layer ML model Mₘᵤₗₜᵢ (via training Mₚ and Mₛ) will generally be lower than the resources needed to train monolithic ML model M of FIG. 1 (assuming the same amount and distribution of training data). Accordingly, the techniques of the present disclosure enable distributed and federated learning to be employed in a wide variety of potentially resource-constrained use cases/scenarios.

Second, because secondary model Mₛ is trained on labeled training data instances that are determined to have high training value and because primary model Mₚ (which can be queried quickly due to its small size/complexity) is used as a first stage “filter” during query processing, the overall ML performance of multi-layer ML model Mₘᵤₗₜᵢ (in terms of accuracy and speed) will generally be comparable to monolithic ML model M. In some cases, the ML performance of Mₘᵤₗₜᵢ may exceed that of M, depending on the nature of the local training datasets and the specific function used to compute training value measures.

It should be appreciated that FIGS. 1-3 are illustrative and not intended to limit embodiments of the present disclosure. For example, although FIGS. 1 and 3 depict a centralized parameter server 108 that is responsible for aggregating and distributing model parameter values among nodes 102(1)-(n)/302(1)-(n), other approaches for communicating parameter information between the nodes are possible. For example, in a particular embodiment each node can locally implement a portion of the logic of parameter server 108 and thereby directly exchange parameter update messages with each other.

Further, while FIG. 2 depicts one conventional approach for training an ML model in a distributed/federated fashion, a number of other conventional approaches are known in the art. For example, rather than exchanging model parameter values via parameter server 108, in certain embodiments nodes 102(1)-(n)/302(1)-(n) can employ a cryptographic technique known as secure multi-party computation (MPC) to collectively train an ML model in a way that does not reveal their local training datasets to anyone, including each other and parameter server 108. One of ordinary skill in the art will recognize other variations, modifications, and alternatives.

### 3. Multi-Layer Training

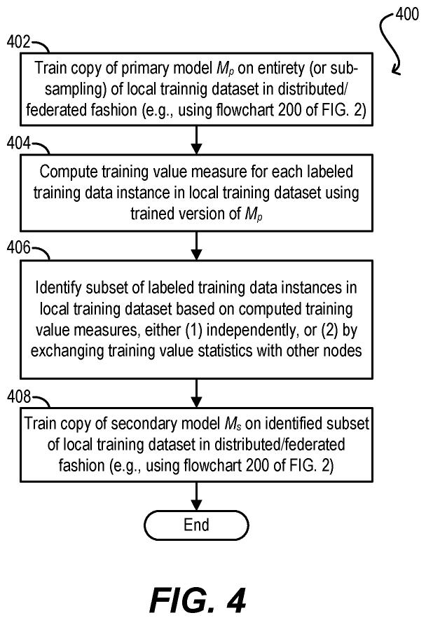

FIG. 4 depicts a flowchart 400 that provides additional details regarding the steps that may be performed by each node 302(i) of FIG. 3 (where i=1, . . . , n) for training global multi-layer ML model Mₘᵤₗₜᵢ according to certain embodiments.

Starting with block 402, node 302(i) can train its copy 306(i) of primary model Mₚ on the entirety of (i.e., all labeled training data instances in) local training dataset 104(i), or certain sampled data instances in local training dataset 104(i), in a distributed/federated manner. For example, in one set of embodiments node 302(i) can perform this training using the parameter-based distributed/federated training approach shown in FIG. 2, such that the node iteratively trains/re-trains local copy 306(i) of Mₚ based on local training dataset 104(i) and aggregated parameter updates received from parameter server 108. In other embodiments, node 302(i) can perform this training using an alternative distributed/federated training approach, such as an MPC-based approach as discussed in section (2) above. The end result of this step is a trained version of primary model Mₚ that is consistent (or in other words, globally shared) across all nodes 302(1)-(n).

At block 404, node 302(i) can compute a training value measure for each labeled training data instance in local training dataset 104(i) using its copy 306(i) of the trained version of Mₚ. As noted previously, this measure quantifies the value or usefulness of the labeled training data instance for training purposes (i.e., to what degree using the labeled training data instance for training an ML model will change/affect the resulting trained model). In one set of embodiments, node 302(i) can compute the training value measure for a given labeled training data instance d with label y by (1) providing d as input to copy 306(i) of the trained version of Mₚ, (2) generating, via copy 306(i) of the trained version of Mₚ, a prediction p for d, and (3) computing a function of the distance between p and y (which indicates how easy or difficult it was for the trained version of Mₚ to generate a correct prediction for d). According to this formulation, a large distance between p and y can indicate that labeled training data instance d was difficult for the trained version of Mₚ to predict, and thus d has a relatively higher training value (because training an ML model using d will most likely have a significant impact on the performance of the trained model). Conversely, a small distance between p and y can indicate that labeled training data instance d was easy for the trained version of Mₚ to predict, and thus d has a relatively lower training value (because training an ML model using d will most likely have a small/insignificant impact on the performance of the trained model).

In alternative embodiments node 302(i) can employ other training value computation methods, such as the “predictability”-based method mentioned in section (2) above.

At block 406, node 302(i) can identify a subset of labeled training data instances in local training dataset 104(i) to be used for training secondary model Mₛ based on the training value measures computed at block 404. In one set of embodiments, node 302(i) can perform this identification in an independent manner that is solely based on the training value measures of its local training dataset. For example, node 302(i) may apply a rule to select the top 10% data instances in local training dataset 104(i) with the highest training value measures. As another example, node 302(i) may apply a rule that performs a stochastic sampling, such that labeled training data instances with higher training value measures in local training dataset 104(i) have a progressively higher chance of being sampled/selected.

In other embodiments, node 302(i) can perform the subset identification at block 406 by exchanging statistics (using, e.g., a logic server that is similar to parameter server 108) regarding the training value measures of its local training dataset with other nodes. For instance, node 302(i) may transmit a histogram of training value measures for local training dataset 104(i) to every other node 302(j) via the logic server and in turn receive such a histogram from every other node 302(j) via the logic server. Node 302(i) can then identify the subset of its local dataset 104(i) based on its own statistics and the statistics received from the other nodes, such that one or more global properties across the subsets of those nodes are optimized. In this way, node 302(i) (as well as the other nodes) can maximize the overall training value of the subsets as a collective whole.

To better understand this, assume the labeled training data instances in local training dataset 104(1) of node 302(1) have training value measures in the range of 0.2 to 0.5 (i.e., relatively low) and the labeled training data instances in local training dataset 104(2) of node 302(2) have training value measures in the range of 0.6 and 0.9 (i.e., relatively high). In this scenario, if nodes 302(1) and 302(2) were to each identify their subsets independently by, e.g., taking the top 10% most valuable labeled training data instances from local training datasets 104(1) and 104(2) respectively, that will result in a sub-optimal global allocation because all of node 302(2)'s labeled training data instances have higher training values than node 302(1)'s labeled training data instances. Accordingly, it is preferable from a global perspective for node 302(2) to select the top 20% most valuable labeled training data instances from its local training dataset 302(2) while node 302(1) selects none from its local training dataset 302(1). This type of “cross-node aware” allocation is possible if nodes 302(1) and 302(2) exchange statistics regarding their local training datasets as explained above.

It should be noted that in some cases, the exchange of statistics between nodes 302(1)-(n) may allow the nodes glean some information regarding their respective local training datasets, which is not permissible under federated learning. In these cases, if strict privacy of local training datasets 104(1)-(n) is needed, nodes 302(1)-(n) can use MPC to perform statistics-based subset identification without revealing those statistics to each other or to the intermediary logic server.

Finally, at block 408, node 302(i) can train its copy 308(i) of secondary model Mₛ on the subset of local dataset 104(i) identified at block 406 in a distributed/federated manner. As with the training of primary model Mₚ, node 302(i) can perform this training of secondary model Mₛ using the parameter-based distributed/federated training approach shown in FIG. 2 or any other distributed/federated training approach known in art. The end result of this step is a trained version of secondary model Mₛ that is consistent/globally shared across all nodes 302(1)-(n).

### 4. Multi-Layer Query Processing

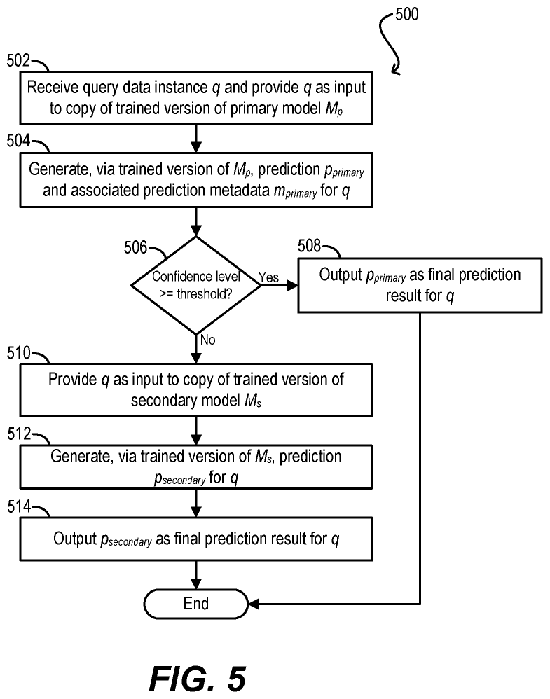

FIG. 5 depicts a flowchart 500 that provides additional details regarding the steps that may be performed by each node 302(i) of FIG. 3 (where i=1, . . . , n) for processing an incoming query data instance q using global multi-layer ML model Mₘᵤₗₜᵢ and thereby generating a prediction for q according to certain embodiments. Flowchart 500 assumes that model Mₘᵤₗₜᵢ (and its constituent sub-models Mₚ and Mₛ) have been trained per flowchart 400 of FIG. 4.

Starting with block 502, node 302(i) can receive query data instance q and provide q as input to its copy 306(i) of the trained version of primary model Mₚ. In response, the trained version of My can generate a prediction p_{primary} for q and associated prediction metadata m_{primary} indicating the degree of confidence (e.g., confidence level) that My has in the correctness of p_{primary} (block 504).

At block 506, node 302(i) can check whether the confidence level indicated by m_{primary} is equal to or above a threshold. If the answer is yes, node 302(i) can output p_{primary} as the final prediction result for query data instance q (block 508) and the flowchart can end.

If the answer at block 506 is no, node 302(i) can provide q as input to its copy 308(i) of the trained version of secondary model Mₛ (block 510). In response, the trained version of Mₛ can generate a prediction p_{secondary} for q (block 512).

Finally, at block 514, node 302(i) can output p_{secondary} as the final prediction result for query data instance q and the flowchart can end.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
training, by a computing node in a plurality of computing nodes, a first machine learning (ML) model on a local training dataset comprising a plurality of labeled training data instances, wherein the training of the first ML model is performed using a distributed or federated training approach across the plurality of computing nodes, and wherein the training of the first ML model results in a trained version of the first ML model;
computing, by the computing node using the trained version of the first ML model, a training value measure for each labeled training data instance in the local training dataset, the training value measure indicating a degree of usefulness of the labeled training data instance for ML training;
identifying, by the computing node, a subset of the plurality of labeled training data instances in the local training dataset based at least in part on the computed training value measures; and
training, by the computing node, a second ML model on the subset, wherein the training of the second ML model is performed using the distributed or federated training approach across the plurality of computing nodes, and wherein the training of the second ML model results in a trained version of the second ML model.

2. The method of claim 1 wherein the second ML model is larger or more complex in structure than the first ML model.

3. The method of claim 1 wherein computing the training value measure for each labeled training data instance comprises:
generating, using the trained version of the first ML model, a prediction for the labeled training data instance; and
computing the training value measure as a function of a distance between the prediction and a label of the labeled training data instance.

4. The method of claim 1 wherein identifying the subset comprises:
transmitting first statistics regarding the computed training value measures to other computing nodes in the plurality of computing nodes.

5. The method of claim 4 wherein identifying the subset further comprises:
receiving, from said other computing nodes, second statistics regarding training value measures computed by said other computing nodes; and
identifying the subset based on the first statistics and the second statistics.

6. The method of claim 5 wherein the transmitting of the first statistics and the receiving of the second statistics is performed using secure multi-party computation (MPC).

7. The method of claim 1 further comprising:
receiving a query data instance;
generating, via the trained version of the first ML model, a first prediction for the query data instance and a confidence level for the first prediction;
if the confidence level for the first prediction meets or exceeds a threshold, outputting the first prediction as a final prediction result for the query data instance; and
if the confidence level for the first prediction does not meet or exceed the threshold:
generating, via the trained version of the second ML model, a second prediction for the query data instance; and
outputting the second prediction as the final prediction result for the query data instance.

8. A non-transitory computer readable storage medium having stored thereon program code executable by a computing node in a plurality of computing nodes, the program code causing the computer system to execute a method comprising:
training a first machine learning (ML) model on a local training dataset comprising a plurality of labeled training data instances, wherein the training of the first ML model is performed using a distributed or federated training approach across the plurality of computing nodes, and wherein the training of the first ML model results in a trained version of the first ML model;
computing, using the trained version of the first ML model, a training value measure for each labeled training data instance in the local training dataset, the training value measure indicating a degree of usefulness of the labeled training data instance for ML training;
identifying a subset of the plurality of labeled training data instances in the local training dataset based at least in part on the computed training value measures; and
training a second ML model on the subset, wherein the training of the second ML model is performed using the distributed or federated training approach across the plurality of computing nodes, and wherein the training of the second ML model results in a trained version of the second ML model.

9. The non-transitory computer readable storage medium of claim 8 wherein the second ML model is larger or more complex in structure than the first ML model.

10. The non-transitory computer readable storage medium of claim 8 wherein computing the training value measure for each labeled training data instance comprises:
generating, using the trained version of the first ML model, a prediction for the labeled training data instance; and
computing the training value measure as a function of a distance between the prediction and a label of the labeled training data instance.

11. The non-transitory computer readable storage medium of claim 8 wherein identifying the subset comprises:
transmitting first statistics regarding the computed training value measures to other computing nodes in the plurality of computing nodes.

12. The non-transitory computer readable storage medium of claim 11 wherein identifying the subset further comprises:
receiving, from said other computing nodes, second statistics regarding training value measures computed by said other computing nodes; and
identifying the subset based on the first statistics and the second statistics.

13. The non-transitory computer readable storage medium of claim 12 wherein the transmitting of the first statistics and the receiving of the second statistics is performed using secure multi-party computation (MPC).

14. The non-transitory computer readable storage medium of claim 8 wherein the method further comprises:
receiving a query data instance;
generating, via the trained version of the first ML model, a first prediction for the query data instance and a confidence level for the first prediction;
if the confidence level for the first prediction meets or exceeds a threshold, outputting the first prediction as a final prediction result for the query data instance; and
if the confidence level for the first prediction does not meet or exceed the threshold:
generating, via the trained version of the second ML model, a second prediction for the query data instance; and
outputting the second prediction as the final prediction result for the query data instance.

15. A computing node comprising:
a processor; and
a non-transitory computer readable medium having stored thereon program code that, when executed, causes the processor to:
train a first machine learning (ML) model on a local training dataset comprising a plurality of labeled training data instances, wherein the training of the first ML model is performed using a distributed or federated training approach across a plurality of computing nodes including the computing node, and wherein the training of the first ML model results in a trained version of the first ML model;
compute, using the trained version of the first ML model, a training value measure for each labeled training data instance in the local training dataset, the training value measure indicating a degree of usefulness of the labeled training data instance for ML training;
identify a subset of the plurality of labeled training data instances in the local training dataset based at least in part on the computed training value measures; and
train a second ML model on the subset, wherein the training of the second ML model is performed using the distributed or federated training approach across the plurality of computing nodes, and wherein the training of the second ML model results in a trained version of the second ML model.

16. The computing node of claim 15 wherein the second ML model is larger or more complex in structure than the first ML model.

17. The computing node of claim 15 wherein the program code that causes the processor to compute the training value measure for each labeled data instance comprises program code that causes the processor to:
generate, using the trained version of the first ML model, a prediction for the labeled training data instance; and
compute the training value measure as a function of a distance between the prediction and a label of the labeled training data instance.

18. The computing node of claim 15 wherein the program code that causes the processor to identify the subset comprises program code that causes the processor to:
transmit first statistics regarding the computed training value measures to other computing nodes in the plurality of computing nodes.

19. The computing node of claim 18 wherein the program code that causes the processor to identify the subset further comprises program code that causes the processor to:
receive, from said other computing nodes, second statistics regarding training value measures computed by said other computing nodes; and
identify the subset based on the first statistics and the second statistics.

20. The computing node of claim 19 wherein the transmitting of the first statistics and the receiving of the second statistics is performed using secure multi-party computation (MPC).

21. The computing node of claim 15 wherein the program code further causes the processor to:
receive a query data instance;
generate, via the trained version of the first ML model, a first prediction for the query data instance and a confidence level for the first prediction;
if the confidence level for the first prediction meets or exceeds a threshold, output the first prediction as a final prediction result for the query data instance; and
if the confidence level for the first prediction does not meet or exceed the threshold:
generate, via the trained version of the second ML model, a second prediction for the query data instance; and
output the second prediction as the final prediction result for the query data instance.
